(19) United States
(12) Patent Application Publication
(10) Pub. No.: US 2010/0066216 A1
(43) Pub. Date: Mar. 18, 2010

(54) QUANTUM MOTOR

(75) Inventors: Hidetoshi Kusumi, Nagoya-shi (JP); Tomasz Blachowicz, Gliwice (PL); Hiromichi Yanagihara, Brussels (BE); Marleen De Weser, Wilsele (BE); Jonas Ambeck-Madsen, Brussels (BE); Gabriel Othmezouri, Brussels (BE); Igor Stankovic, Belgrade (SV); Ryuji Funayama, Yokohama-shi (JP); Katsuhiro Sakai, Hadano-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/448,790

(22) PCT Filed: Jan. 11, 2007
(86) PCT No.: PCT/JP2007/050640

§ 371 Date: Nov. 19, 2009

(51) Int. Cl. H02K 11/00; H02K 21/00

(52) U.S. Cl. 310/68 R; 310/152

(57) ABSTRACT

To provide a quantum motor capable of reliably carrying out rotation. A quantum motor includes a rotor containing a functional material of which quantum characteristic is externally controllable, an N pole permanent magnet and an S pole permanent magnet applying magnetic field to the rotor, and a light source varying the quantum characteristic of the rotor. The light source varies the quantum characteristic of the rotor, so that rotation force is generated in the rotor and the rotor rotates.

### TECHNICAL FIELD

The present invention relates to a quantum motor, and more particularly to a quantum motor rotating as a result of action between magnetic field and the rotor.

### BACKGROUND ART

A motor utilizing a concept of quantum has conventionally been disclosed, for example, in Japanese Patent Laying-Open No. 2001-268957.

### DISCLOSURE OF THE INVENTION

The conventional quantum motor, however, has been unable to obtain sufficient rotation force.

From the foregoing, the present invention was made to solve the above-described problem, and an object of the present invention is to provide a quantum motor capable of obtaining sufficient rotation force.

A quantum motor according to one aspect of the present invention includes: a rotor containing a functional material of which quantum characteristic is controllable; a magnetic field application portion applying magnetic field to the rotor; and a varying portion varying the quantum characteristic of the rotor. The varying portion varies the quantum characteristic of the rotor, so that rotation force is generated in the rotor and the rotor rotates.

In the quantum motor structured as above, the quantum characteristic of the rotor is varied, so that the rotation force is generated in the rotor. Therefore, the quantum motor capable of generating sufficient rotation force can be obtained.

Preferably, the varying portion controls the quantum characteristic of the rotor by externally supplying physical energy to the rotor.

Preferably, the rotor contains an antiferromagnetic material and the functional material.

Preferably, the physical energy is supplied to a part of the rotor.

Preferably, the varying portion varies the quantum characteristic of the rotor, so that a current flows in the rotor and the current and the magnetic field act on each other, so that rotation force is generated in the rotor.

Preferably, the varying portion varies the quantum characteristic of the rotor, so that rotation force is generated in the rotor as a result of magnetic interaction between the rotor and the magnetic field.

A quantum motor according to another aspect of the present invention includes: a rotor containing a material allowing current flow from an irradiated portion to another portion as a result of irradiation of a part of the rotor with electromagnetic wave; a magnetic field application portion applying magnetic field to the rotor; and an irradiation portion irradiating the part of the rotor with the electromagnetic wave. The irradiation portion irradiates the part of the rotor with the electromagnetic wave, so that the current flows from the irradiated portion to another portion and the rotor rotates as a result of interaction between the current and the magnetic field.

In the quantum motor structured as above, the irradiation portion irradiates the part of the rotor with the electromagnetic wave, so that the current flows from the irradiated portion to another portion and the rotor rotates as a result of interaction between the current and the magnetic field. Therefore, the rotor can reliably be rotated, using interaction between the rotor and the magnetic field application portion.

A quantum motor according to yet another aspect of the present invention includes: a rotor containing a material capable of varying orientation of magnetic moment; a magnetic field application portion applying magnetic field to the rotor; and a varying portion capable of acting on the rotor and varying the orientation of the magnetic moment of the rotor. The varying portion adjusts the orientation of the magnetic moment of the rotor in such a manner that, when the rotor moves toward the magnetic field application portion, the rotor and the magnetic field application portion are attracted to each other, and when the rotor moves away from the magnetic field application portion, the rotor and the magnetic field application portion repulse from each other.

In the quantum motor structured as above, the varying portion adjusts the orientation of the magnetic moment of the rotor in such a manner that, when the rotor moves toward the magnetic field application portion, the rotor and the magnetic field application portion are attracted to each other, and when the rotor moves away from the magnetic field application portion, the rotor and the magnetic field application portion repulse from each other. Therefore, the rotor can reliably be rotated, using interaction between the rotor and the magnetic field application portion.

### BRIEF DESCRIPTION OF THE DRAWINGS

FIGS. 1A to 1B show structural formulas of a functional material of the present invention: FIG. 1A shows a structural formula of hydrogen phthalocyanine and FIG. 1B shows a structural formula of phthalocyanine (Me, Pc) partially substituted with a magnetic element.

FIGS. 2A to 2B show structures of a diluted phase of hydrogen phthalocyanine and Me-phthalocyanine: FIG. 2A shows non-diluted MePc and FIG. 2B shows β-phase of Me-phthalocyanine.

FIG. 3 shows an idea for β-phase AM [H₂Pc/MePc] material.

FIG. 4 shows α-phase of AM [H₂Pc/MePc].

FIG. 5 is a perspective view for illustrating a quantum mechanism and schematically showing a structure of a quantum motor according to a first embodiment of the present invention.

FIG. 6 is a perspective view of the quantum motor for illustrating arrangement of LEDs provided in a light source.

FIGS. 7A to 7B show functional materials: FIG. 7A shows a perspective view of the functional material not irradiated with light, and FIG. 7B shows a perspective view of the functional material irradiated with light.

FIGS. 8A to 8B are plan views of a permanent magnet: FIG. 8A shows a plan view of an N pole permanent magnet, and FIG. 88 is a plan view of an S pole permanent magnet.

FIG. 9 shows elementary magnetic moment.

FIGS. 10A to 10C illustrate a quantum motor: FIG. 10A shows a perspective view of a rotor and a stator of the quantum motor, FIG. 10B shows an exploded perspective view, and FIG. 10C shows an enlarged cross-sectional view of the rotor.

FIGS. 11A to 11C are plan views of the rotor: FIG. 11A shows a plan view of a continuous rotor, FIG. 11B shows a plan view of a radially patterned rotor, and FIG. 11C shows a plan view of a rotor radially and circumferentially patterned.

FIGS. 12A to 12D are perspective views of the quantum motor for illustrating a flow of electrons: FIG. 12A shows a perspective view of the stator and the rotor, FIG. 12B shows an exploded perspective view of the quantum motor, FIG. 12C shows a plan view of the rotor, and FIG. 12D is a graph showing relation between positions of electrons and energy.

FIGS. 13A to 13C show the quantum motor for illustrating spin reversal: FIG. 13A shows a perspective view of the rotor and the stator of the quantum motor, FIG. 13B shows an enlarged view of the functional material, and FIG. 13C illustrates spin reversal.

FIG. 14 is a perspective view of a quantum motor according to a second embodiment of the present invention.

FIG. 15 is a perspective view illustrating the quantum motor according to the second embodiment of the present invention in detail.

FIG. 16 shows a structural formula of F₁₆CuPc composing the functional material.

FIG. 17 shows a structural formula of VOPc composing the functional material.

### BEST MODES FOR CARRYING OUT THE INVENTION

An embodiment of the present invention will be described hereinafter with reference to the drawings. In the embodiment below, as the same or corresponding elements have the same reference characters allotted, detailed description thereof will not be repeated.

### First Embodiment

### 1. Basic Concept and Mechanism to Produce Motion Using Quantum Effects

Organic molecular magnets can base on different magnetic mechanisms (quantum superexchange) which do not rely on direct exchange interactions like in conventional ferromagnetic metal alloys, but on magnetism mediated by electron spins. From that assumption, can result magnetic materials with pure or without a domain structure, which can be switched (rotors in electric machines) much faster than in conventional materials (higher speeds of rotations at a given power supply).

New materials, prepared as thin layer, could be used as a surface layer of a rotor in electric engines to improve transfer of the magnetic flux between a stator and a rotor. Higher speeds of rotation could result in reduced depth of magnetic flux penetration into a bulk of materials (less intensity of wired currents). In an ideal, hypothetic case, stators and rotors in an electric machine should interact magnetically through subsurface regions only.

In summary, quantum magnetism in organic molecular substances should result in materials with completely new, very fast, domain-less magnetic switching at temperatures from liquid nitrogen (140K) up to 300K and above.

### 1.1 Material

From physical point of view, the development of molecular based magnetism will evolve through the following steps.

a) Hydrogen Phthalocyanine (H₂Pc) as an Input (Base) Material

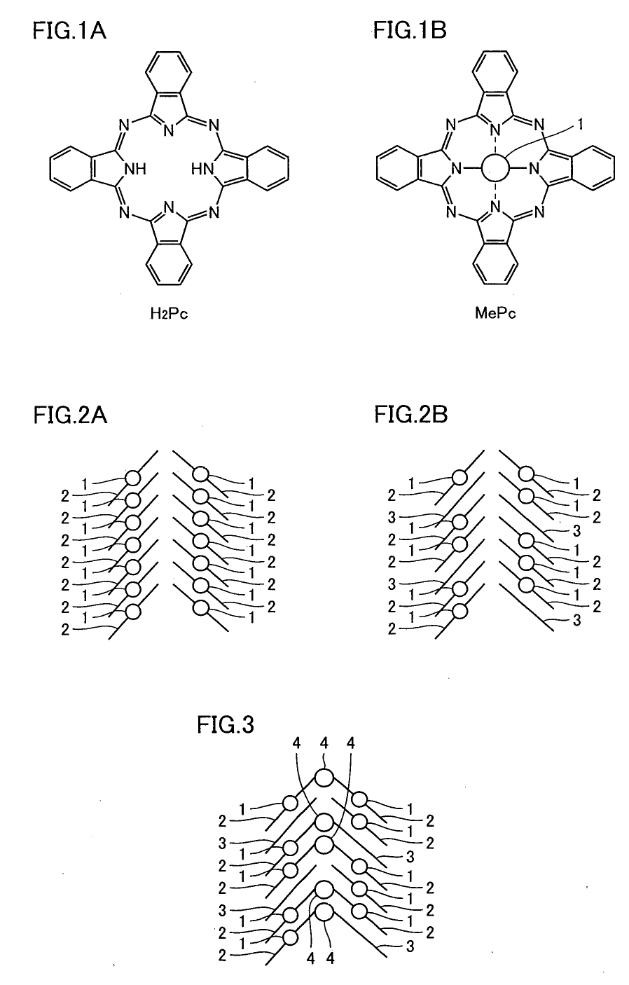

FIGS. 1A to 1B show structural formulas of a functional material of the present invention: FIG. 1A shows a structural formula of hydrogen phthalocyanine and FIG. 1B shows a structural formula of phthalocyanine (Me, Pc) partially substituted with a magnetic element.

b) Modification of Hydrogen Phthalocyanine by Metal Substitutions-Magnetic Elements Substitutions (Co, Fe, Ni,)

FIG. 1B shows phthalocyanine (Me, Pc) partially substituted with a magnetic element. A distance between magnetic atoms is large enough (not larger than 2.5 nm) to warrant paramagnetic behavior at very low temperature (not higher than 5K).

c) Preparation of Diluted Phases of H₂Pc/MePc

FIGS. 2A to 2B show structures of a diluted phase of hydrogen phthalocyanine and Me-phthalocyanine: FIG. 2A shows non-diluted MePc and FIG. 2B shows β-phase of Me-phthalocyanine.

Referring to FIG. 2A, in Me phthalocyanine, a magnetic element 1 is coupled to phthalocyanine 2. Magnetic element 1 is implemented by a metal element such as Co, Fe, Ni, and the like. Referring to FIG. 2B, when diluted with hydrogen phthalocyanine 3, hydrogen phthalocyanine 3 is interposed between Me phthalocyanines. Empty spaces are needed for superexchange magnetic-forces mediators (electron).

d) Preparation of Mixed Phases of Diluted H₂Pc/MePc with Alkaline Metals (AM), like Na, K, Al, Mg

These metals should work as sources of electrons to mediate (superexchange) magnetic quantum forces between magnetic atoms located at centers of Pc molecules. This modification should warrant magnetic behavior at higher temperatures (important for work with high-temperature superconductors, room temperatures and above).

FIG. 3 provides the idea for the β-phase AM [H₂Pc/MePc] material. Referring to FIG. 3, an alkaline metal atom 4 is interposed between metallophthalocyanines or hydrogen phthalocyanines, and couples these components to each other.

e) The Whole Solution should be Checked Both for the β-Phase and the α-Phase Of Materials.

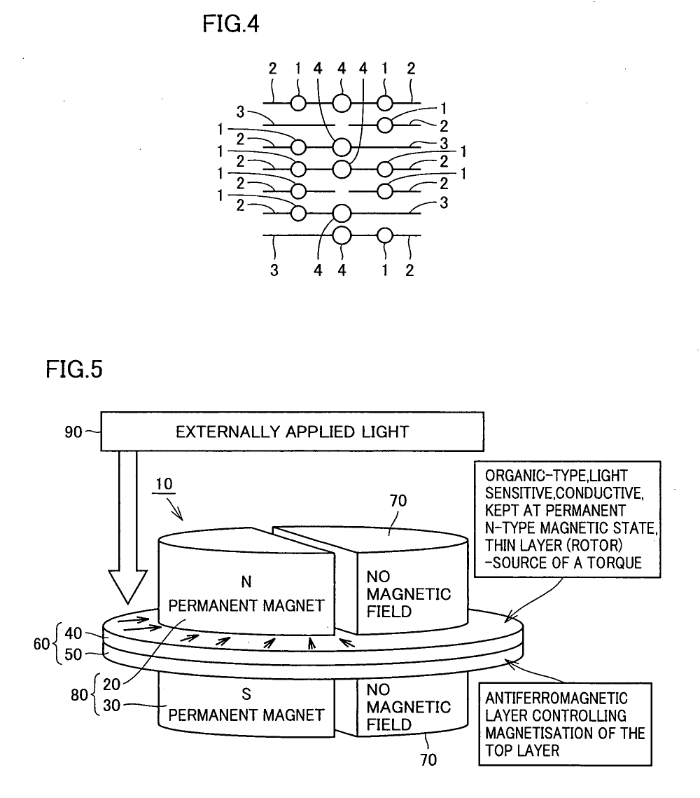

FIG. 4 shows the α-phase of AM [H₂Pc/MePc]. Referring to FIG. 4, in the case of the α-phase, the hydrogen phthalocyanine and the metallophthalocyanine are located on the same plane.

A distance between molecule planes depends on sample growing conditions. The distance determines a force of quantum interaction between magnetic atoms and molecules. A choice between the α and the β phases depends also on macroscopic mechanical (elastic) properties, and should be tested during experiments (by MOKE and BLS).

Proposed type of materials was invented in 1996 by A. R. Harutyunyan et al. in the Naₓ[(CoPc)_{y}(H₂Pc)_{1-y}] system (with x=1.7, y=0.2 or 0.11). They obtained hysteresis-loop behavior at room temperatures. However, other magnetic elements like Ni and Fe, and other alkaline metals, in different proportions, were not tested.

### 1.2. Torque Producing Mechanism Using the Material Mentioned in 1.1

A torque results from classical and quantum mechanisms.

In the classical mechanism, electric carriers which propagate from external parts of lighted rotor to its center are influenced by the Lorenz-type force. Such currents result from a difference between local electric carriers concentrations of the lighted (near edge) and not lighted parts of a rotor. A half of a ring, which is not kept in a magnetic field, is lighted (pumped) by light. This general idea of classical mechanism is provided in the drawings.

FIG. 5 is a perspective view for illustrating the quantum mechanism and schematically showing a structure of a quantum motor according to a first embodiment of the present invention. It cannot be excluded that there exist other types of rotor lighting using, for example, a set of holes distributed around rotor 60.

As shown in FIG. 5, a quantum motor 10 includes a rotor 60, an N pole permanent magnet 20 and an S pole permanent magnet 30 provided above and under rotor 60 respectively, a light source 90, and a non-magnetic field 70. Rotor 60 is implemented as a layered structure of a functional material 40 and an antiferromagnetic material 50. FIG. 5 shows a general principle in which an organic, light-sensitive and magnetic material is used in order to generate mechanical torque. The organic, light-sensitive and conductive material is used as functional material 40, and located between N pole permanent magnet 20 and S pole permanent magnet 30. Torque is generated by functional material 40.

Antiferromagnetic material 50 is arranged, for example, on a substrate, and functional material 40 is provided so that it comes in contact with antiferromagnetic material 50. Antiferromagnetic material 50 controls a magnetic characteristic of functional material 40.

Light source 90 irradiates functional material 40 with light, and accordingly, orientation of spins in functional material 40 can be varied.

In the quantum mechanism, a torque can be enhanced by controlling a magnetic state of a layer of organic-type functional material 40 due to quantum type exchange-bias interaction between the layer of rotor 60 and attached antiferromagnetic material 50. This will cause removal of the ring from an externally applied magnetic field (magnetic field applied by N pole permanent magnet 20 and S pole permanent magnet 30). A quantum based energy results from superexchange energy or double-exchange energy between spins of interacting molecules in an organic material. A spin orientation can be influenced by external magnetic field and what seems the most important advantage of organic materials, by externally applied light (possibly laser light from diodes). Namely, laser or a diode is used as light source 90.

Functional material 40 serving as the organic magnetic-type layer is sensitive to light and causes changes of conductivity in some orders (10⁴ or more). This criterion can be fulfilled by diluted phases of H₂Pc/MePc shown in FIGS. 1 to 4 (pure phthalocyanine (H₂Pc) diluted by metallic type phthalocyanine (MePc)). The MePc molecule of a high symmetry should be only treated as a basic element from which new material—the magnetic, light sensitive and transparent organic, two-dimensional set of ferromagnetically or antiferromagnetically interacting spins.

Bilayers (ferromagnetic/antiferromagnetic materials) can be ordered into multilayered structure to enhance the performance of future devices.

Quantum motor 10 consists of mainly four parts, that is, rotor 60, N pole permanent magnet 20 and S pole permanent magnet 30 constituting a pair of stators, light source 90 implemented by a diode unit (controller), and a shaft.

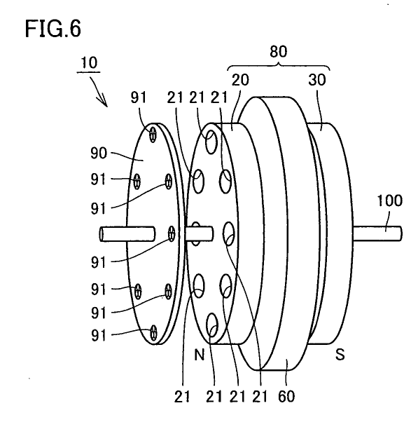

FIG. 6 is a perspective view of the quantum motor for illustrating arrangement of LEDs provided in the light source. A plurality of LEDs 91 (light-emitting diodes) are arranged in light source 90, and a circuit for supplying electric power to LEDs 91 is also provided.

N pole permanent magnet 20 is arranged so as to face light source 90. A plurality of holes 21 are provided in N pole permanent magnet 20, through which light emitted from LEDs 91 provided in light source 90 passes and rotor 60 is irradiated with that light.

Rotor 60 is fixed to a shaft 100, and rotates together with shaft 100. In addition, rotor 60 is sandwiched between stators 80.

S pole permanent magnet 30 implementing a part of stator 80 is arranged so as to face rotor 60.

Stator 80 consists of two parts of polarities, that is, N pole permanent magnet 20 and S pole permanent magnet 30, in order to give an external magnetic field to rotor 60.

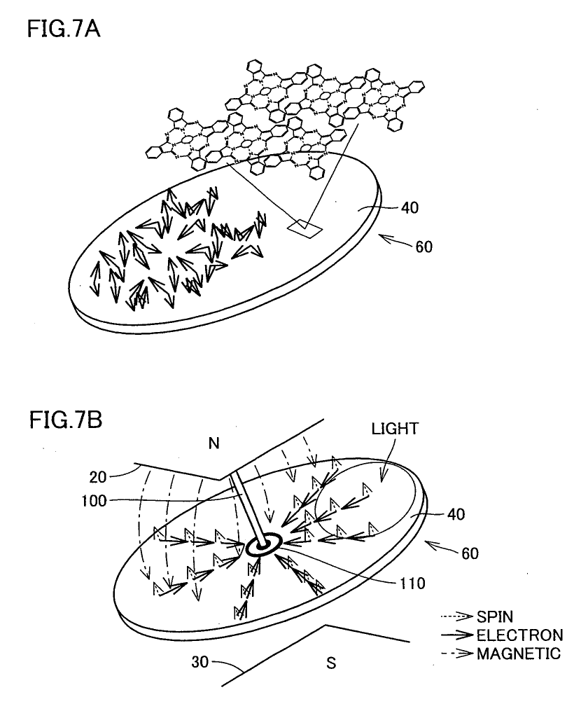

FIGS. 7A to 7B show functional materials: FIG. 7A shows a perspective view of the functional material not irradiated with light, and FIG. 7B shows a perspective view of the functional material irradiated with light. As shown in FIG. 7A, phthalocyanine containing a magnetic element is arranged on the surface of functional material 40 serving as an organic material layer. The organic material should be metastable to an externally applied physical energy like light, for example, and changes its electron potentials or electron spins with externally applied physical energy. As shown in FIG. 7B, when a part is irradiated with light, the spin is oriented and electron flow toward the center takes place. Rotor 60 is supported on shaft 100 by means of a magnetic bearing 110.

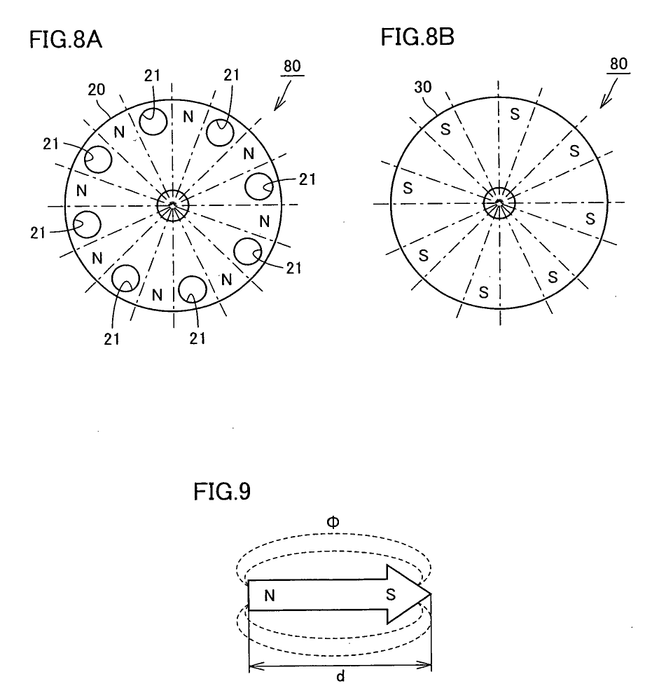

FIGS. 8A to 8B are plan views of a permanent magnet: FIG. 8A shows a plan view of an N pole permanent magnet, and FIG. 8B is a plan view of an S pole permanent magnet. As shown in FIGS. 8A and 8B, each of N pole permanent magnet 20 and S pole permanent magnet 30 is separated into several parts. Each of N pole permanent magnet 20 and S pole permanent magnet 30 implements stator 80. The permanent magnet is located in every other section in the rotor. Stator 80 also has holes 21 or slits to allow the rotor being exposed to light from light source 90 implemented as an LED array unit. Each hole 21 is located in every other section where the magnets are not located. Magnetic bearing is used for the shaft.

### 2.1 Theoretical Description of the Effect

A mechanical torque N which is a product of a force and an arm is expressed in the following equation.

\vec{N}=\vec{r}×\vec{F}

Assume that on the elementary magnetic moment (a spin) acts a force. This force is proportional to magnetic moment p of the spin, that is, expressed in the following equation

F=p·H

where H represents the externally applied magnetic field.

FIG. 9 shows elementary magnetic moment. Magnetic flux Φ is generated by the spin. The magnetic flux generates the magnetic moment, and the magnetic moment is proportional to the magnetic flux.

The magnetic moment is proportional to a magnetic stream produced by a spin (FIG. 9). Its value can be calculated from a macroscopic parameter of magnetic material—magnetization M. Thus, magnetic moment p is expressed in the following equation

p=M/(μ₀·d)

where μ₀ represents the magnetic permeability of vacuum, and d represents the magnetic moment length. Next, force F acting on magnetic moment p located in the external magnetic field H=B/μ₀ is equal to the value as follows.

F=p·(B/μ₀)

Then, mechanical moment N_{P} acting on magnetic moment p, which is mounted somehow at the distance (radius) R from the rotor axis, can be estimated as follows.

$${N}_{p} = 0.5 \cdot ( \frac{M}{d} ) \cdot B \cdot R$$

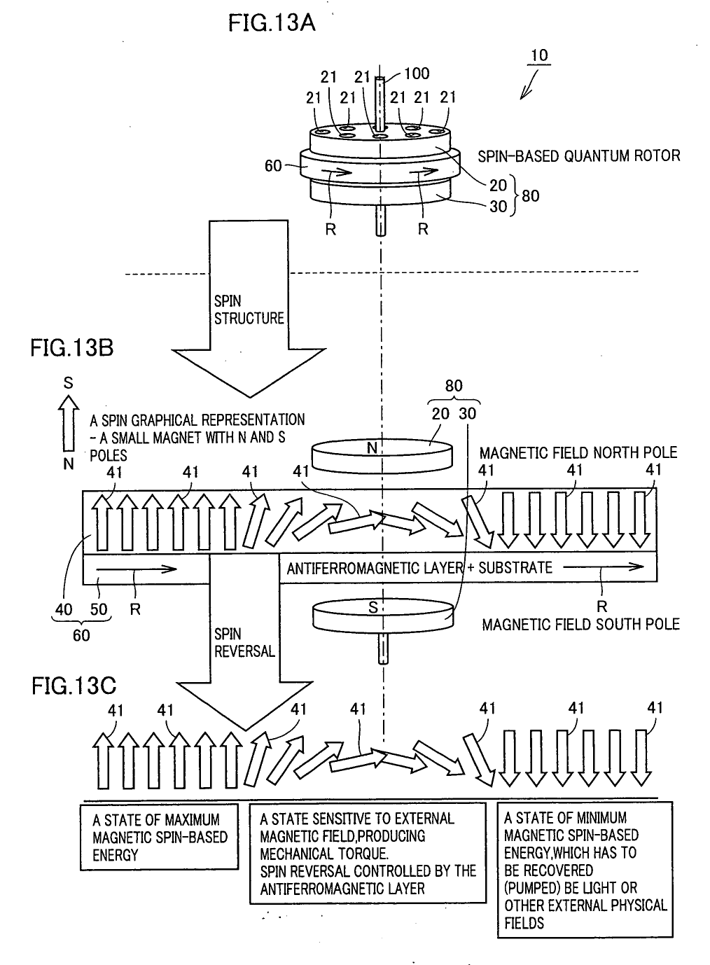

This simple estimation shows importance of using thin layered technology (as compared with FIGS. 13A to 13C), because the d parameter represents not only the length of an elementary magnet (spin) but also the layer's range of thickness. For the purposes on current project, this range is equal to approximately (from 5 nm to 100 nm) for a single ferromagnetic layer.

The M quantity can be treated as a macro-parameter of given material. In this way, it represents total magnetization (magnetic moment) of a sample (rotor). For non-magnetic phthalocyanines, it is equal to 0.001 to 0.002 emu/g (Am·m²/kg). Assuming following data: diameter of the rotor 2R=5 cm, magnetic field induction of the external field B=1T, layer thickness d=10 nm, we obtain Nₚ=0.125·10⁴Nm for the mechanical torque. This gives a power of the order of 10⁷W (1000 kW) for the rotor (for one layer=10 nm) working with the angular frequency of 1000 Hz. This perfect case does not include stray fields, energy needed for spin reversal (as compared with FIGS. 13A to 13C). For example, estimation of this energy for known metallic case (cobalt) provides the value of 5 kW for 1 liter to be switched with frequency of 1000 Hz. However, it should be pointed that the quantum energy in metallic materials results from (in macro scale) magnetic anisotropies of crystalline origin. In a case of magnetic organic materials, this energy might be lower.

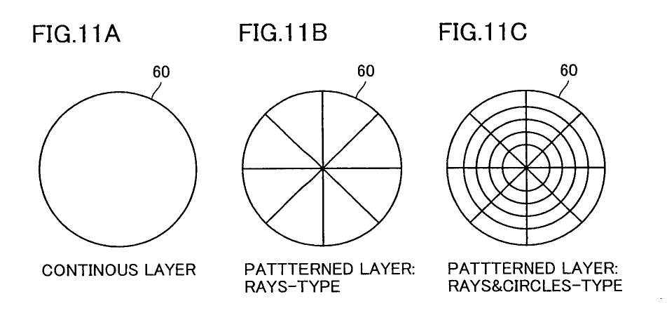

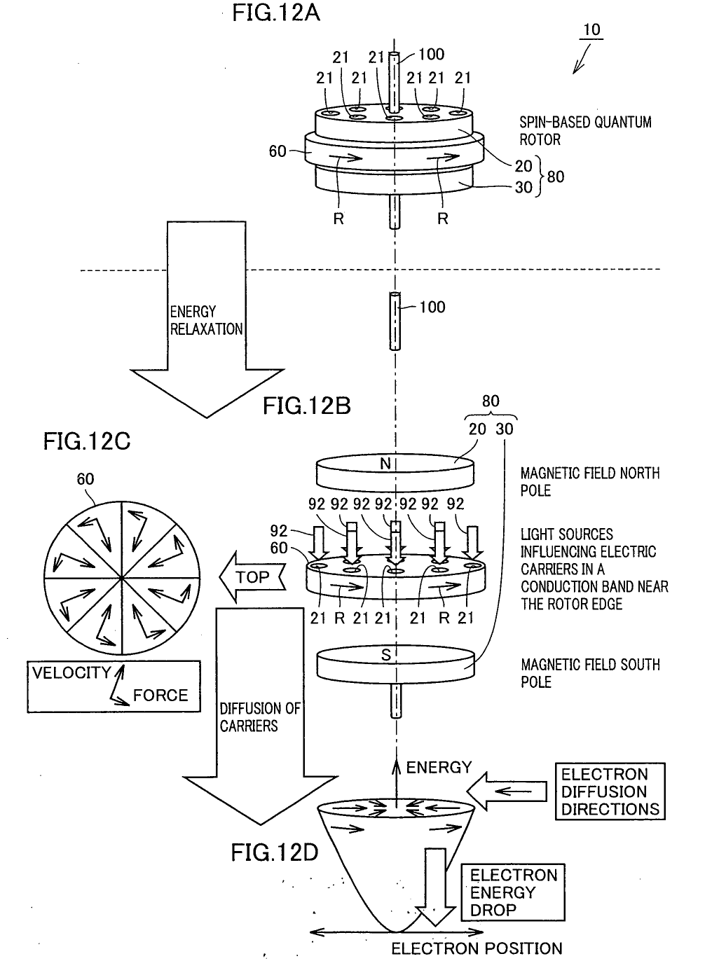

The classical mechanism of a torque production (FIGS. 12A to 12D) is associated with local light influence and evidently can be applied mainly in semiconductors. The advantage of semiconductors is that concentration of electric carriers can be changed locally in space (in the region near rotor's edge). The disadvantage of this mechanism is that diffusive currents are thermal in nature and are not so fast as normal currents. It could be assumed that this weak effect can compensate for negative factors resulting from the Lenz's law during current flow. On the other hand, the flow can be blocked in a case of patterned rotors (as compared with FIGS. 11A to 11C) reducing a problem of torque creation to the quantum mechanism only.

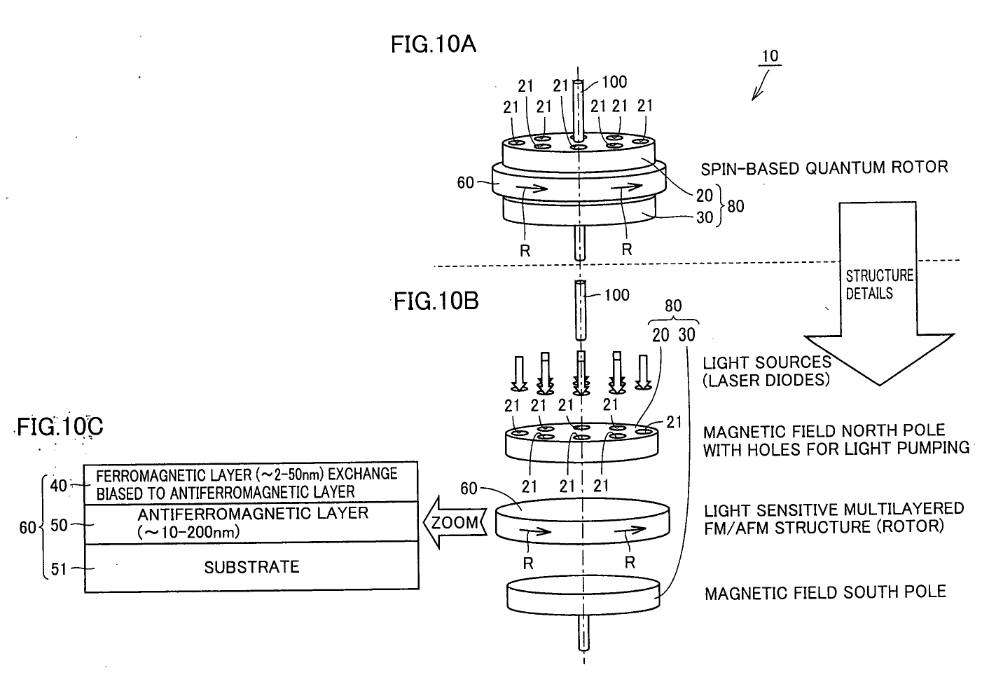

FIGS. 10A to 10C illustrate a quantum motor: FIG. 10A shows a perspective view of a rotor and a stator of the quantum motor, FIG. 10B shows an exploded perspective view, and FIG. 10C shows an enlarged cross-sectional view of the rotor. The light emitted from the light source implemented by a laser diode passes through holes 21 in N pole permanent magnet 20 and reaches rotor 60. N pole permanent magnet 20 which is a part of stator 80 has holes 21 for supplying light. Light-sensitive rotor 60 is implemented as a layered structure of the ferromagnetic material and the antiferromagnetic material. As shown in FIG. 10C, antiferromagnetic material 50 is provided on a substrate 51, and functional material 40 is provided thereon. Antiferromagnetic material 50 has a thickness from 10 to 200 nm. Functional material 40 implemented by the ferromagnetic material has a thickness from 2 to 50 nm.

FIGS. 11A and 11B are plan views of the rotor: FIG. 11A shows a plan view of a continuous rotor, FIG. 11B shows a plan view of a radially patterned rotor, and FIG. 11C shows a plan view of a rotor radially and circumferentially patterned. As shown in FIG. 11A, rotor 60 may be formed from one region.

Alternatively, as shown in FIG. 11B, rotor 60 may be divided into a plurality of sections by a line extending radially from the center.

Alternatively, as shown in FIG. 11C, a surface region of rotor 60 may be divided by a radially extending line and a concentric circle.

The permanent magnet may be arranged in the stator in accordance with the divided shape as shown in FIGS. 11B and 11C.

FIGS. 12A to 12D are perspective view of the quantum motor for illustrating a flow of electrons: FIG. 12A shows a perspective view of the stator and the rotor, FIG. 12B shows an exploded perspective view of the quantum motor, FIG. 12C shows a plan view of the rotor, and FIG. 12D is a graph showing relation between positions of electrons and energy. Referring to FIGS. 12A to 12D, when light 92 impinges on rotor 60, electrons flow toward the center as shown in FIG. 12C, which is illustrated in connection with FIG. 12D. Namely, energy of electrons is higher from the center toward the outside, because of irradiation with light 92. Therefore, electrons at an outer peripheral portion where high energy is attained flow toward the center. The flow of electrons toward the center is as shown with an arrow in FIGS. 12A to 12D.

As a result of such electron flow, the current is generated. The current and the magnetic field applied in the orthogonal direction act on each other, and the force in a direction rotating the rotor is generated.

FIGS. 13A to 13C show the quantum motor for illustrating spin reversal: FIG. 13A shows a perspective view of the rotor and the stator of the quantum motor, FIG. 13B shows an enlarged view of the functional material, and FIG. 13C illustrates spin reversal. As shown in FIG. 13A, rotor 60 is arranged between N pole permanent magnet 20 and S pole permanent magnet 30 of stator 80. Rotor 60 is connected to shaft 100.

As shown in FIG. 13B, a spin 41 is present in functional material 40. As a result of change in the orientation of the spin, rotation force in a direction shown with an arrow R is generated by interaction between spin 41 and stator 80. It is configured such that stator 80 and spin 41 are attracted to each other until the orientation of spin 41 is reversed, and stator 80 and spin 41 repulse from each other after the orientation of spin 41 is reversed.

Referring to FIG. 13C, the spin is reversed from a state of maximum magnetic spin-based energy, and entering a state of minimum magnetic spin-based energy, which is recovered by light or other external factors. FIGS. 13A to 13C show in detail spin reversal during torque production based on a quantum mechanism and exchange bias interaction.

A method of controlling the motor will now be described.

The number of rotations of the motor is controlled by changing a switching frequency of the LED serving as light trigger.

Electron excitation level or angular momentum of electron spin can be controlled by changing a color (wavelength) or intensity of light, and hence the torque can be controlled.

In addition, by irradiating the inner side instead of the outer peripheral portion with light so as to reverse the direction of diffusion of excited electrons in FIGS. 8A to 8B, the direction of rotation can be reversed. In other words, by controlling arrangement of the LEDs and the illumination timing, rotation in a forward/reverse direction can be controlled.

If a direction resulting from combination of magnets serving as the external magnetic field with a material in an excited state is assumed as the forward direction, rotational motion in the reverse direction can result from change in the positions of the magnets and combination of the magnets with a material in a rest state as in FIG. 6. Here, if such a stator as freely controlling the external magnetic field with an electromagnetic coil or the like is designed, rotation in a forward/reverse direction can be controlled by externally controlling electromagnetic force.

In addition, if a rotating machine dedicated for power generation is connected to a rotation shaft, regenerative energy as in the conventional motor can be obtained. The present invention can be used, for example, for a quantum linear motor in which a rotation shaft is not provided and the entire system is linearly structured.

Moreover, the present invention can be used as a motor for outdoor use, that employs sunlight as the light source and can semipermanently operate.

Further, the present invention can be used as a solar power generation system, that employs sunlight as the light source, generates power by rotating the rotor, and can semipermanently operate.

In addition, the rotor portion can be implemented as an independent, disk-shaped product, for use as a portable energy source. In this case, it can be used in combination with the external magnetic field and a separate apparatus for supplying light trigger.

Moreover, the present invention can be used as a coating material for protecting a thin film of a metastable organic material, which is necessary in carrying the rotor disk alone.

The present invention is summarized as follows.

(1) According to the present invention, a ferromagnetic such as Ni, Co, Fe, and the like and phthalocyanine are combined to synthesize an electronically or magnetically metastable ferromagnetic material. For synthesizing a base material, hydrogen phthalocyanine serving as a base and metallophthalocyanine of which hydrogen has been substituted with Ni, Co, Fe, and the like are combined to manufacture a synthesized material. As a result of substitution with metal atom, a hole is generated within a molecule. Magnetization of the material can be varied by electron migration in the space or by change in the electron spin in the space.

As to supply of functional electrons, as an electron supply source, hydrogen phthalocyanine/metallophthalocyanine and an alkali metal such as Na, K, Al, Mg, and the like are combined. Electrons supplied from the alkaline metal causes transmission of quantum magnetic force in the material through the molecule, and magnetization of the material can be controlled at room temperatures and above.

(2) Using the material above, external energy such as light is used to control electron density distribution or the electron spin of the material, thus varying the physical property thereof.

(3) In addition, a drive device in accordance with the basic principle that such an operation is performed in external magnetic field set in advance and resultant force acting on the material is extracted as mechanical energy is provided.

(4) FIG. 5 shows a basic configuration for obtaining rotational motion utilizing the basic inventions (1) to (3). Rotor 60 uses the material in paragraph (1) above. The material in paragraph (1) is implemented as a thin film of substantially monomolecular thickness, and combined with antiferromagnetic material 50 to form a layered structure such that a prescribed function is attained particularly in controlling the electron spin, which is also shown in FIGS. 10A to 10C.

One functional material is implemented by a set of two layers. To implement the rotor, the layers of the functional material are superimposed on each other to form a multi-layered structure, and a substrate material is formed as a holding member, as the lowermost layer. The functional material has a thickness (two layers) of 100 to 300 nm. Therefore, for example, if a rotor having thickness t=approximately 1 cm is assumed and if the substrate material has a thickness of 5 mm, the layers of the functional material of the order of several tens of thousands can be superimposed on each other.

(5) If light is employed as the input energy (trigger), rotor 60 should maintain transparency.

(6) As shown in FIG. 5, rotor 60 is arranged within the external magnetic field implemented by a pair of permanent magnets or the like, and the rotation shaft is provided in the center of rotor 60. If a specific part (the outer peripheral portion herein) of rotor 60 is irradiated with light as shown, the metastable portion is excited by the light, the current is generated inside as a result of change in the electron density distribution, and force is applied in the direction at a right angle with respect to the magnetic field and the current, in accordance with Fleming's left-hand rule. The rotor thus starts rotation. At the same time, as the force in the direction repulsive to the external magnetic field is generated as a result of reversal of the electron spin in the metastable portion, the rotation force further increases. On the other hand, neither the external magnetic field nor light trigger is applied to the right half of rotor 60 in FIG. 5, in order to allow the material to rest. By providing such a rest portion, electron energy potential in the material and the electron spin return to the original state, and preparation for next excitation can be made. One of the major features of the present invention resides in alternately arranging the excited portion and the rest portion in the process for converting the quantum energy of the material to mechanical energy as a device output, and it is an important design requirement as a device.

Quantum motor 10 according to the present invention includes: rotor 60 containing functional material 40 of which quantum characteristic is externally controllable; N pole permanent magnet 20 and S pole permanent magnet 30 serving as the magnetic field application portion applying magnetic field to rotor 60; and light source 90 serving as the varying portion varying the quantum characteristic of rotor 60. Light source 90 varies the quantum characteristic of rotor 60, so that rotation force is generated in rotor 60 and rotor 60 rotates.

Light source 90 controls the quantum characteristic of rotor 60 by externally supplying physical energy to rotor 60.

Rotor 60 contains antiferromagnetic material 50 and functional material 40. The physical energy is supplied to a part of rotor 60. Light source 90 varies the quantum characteristic of rotor 60, so that a current flows in rotor 60 and the current and the magnetic field act on each other, whereby rotation force is generated in rotor 60. Light source 90 varies the quantum characteristic of rotor 60, and rotation force is generated in rotor, 60 as a result of interaction between rotor 60 and the magnetic field.

Quantum motor 10 includes: rotor 60 containing a material allowing current flow from an irradiated portion to another portion as a result of irradiation of a part of rotor 60 with electromagnetic wave; N pole permanent magnet 20 and S pole permanent magnet 30 applying magnetic field to rotor 60; and light source 90 serving as the irradiation portion irradiating the part of rotor 60 with the electromagnetic wave. Light source 90 irradiates the part of rotor 60 with the electromagnetic wave, so that the current flows from the irradiated portion to another portion and rotor 60 rotates as a result of interaction between the current and the magnetic field.

### Second Embodiment

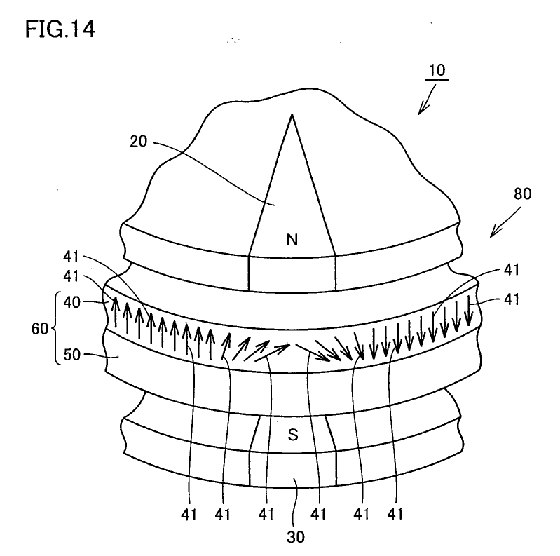

FIG. 14 is a perspective view of a quantum motor according to a second embodiment of the present invention. Referring to FIG. 14, spin 41 is present in functional material 40, and spin 41 is reversed at a certain time point. Here, for example, some kind of external physical force can be used for reversal. In addition, if it is configured such that each spin 41 and N pole permanent magnet 20, S pole permanent magnet 30 implementing stator 80 are attracted to each other before spin 41 is reversed, and spin 41 and N pole permanent magnet 20, S pole permanent magnet 30 repulse from each other after the spin is reversed, the force is applied to rotor 60 and rotor 60 rotates.

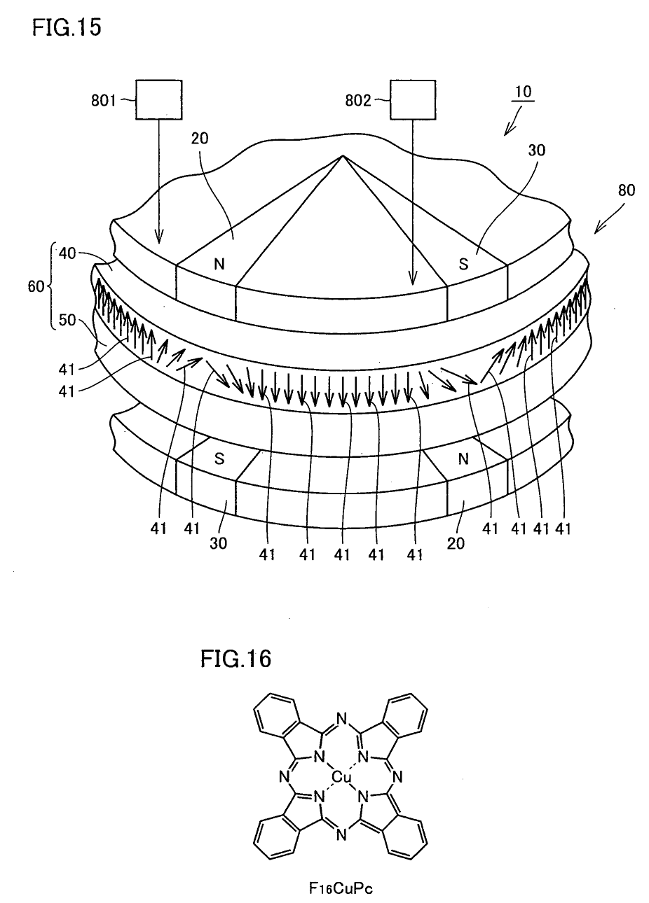

FIG. 15 is a perspective view illustrating the quantum motor according to the second embodiment of the present invention in detail. Referring to FIG. 15, quantum motor 10 includes: rotor 60 containing a material capable of varying the orientation of magnetic moment (spin 41) upon receiving external action; N pole permanent magnet 20 and S pole permanent magnet 30 serving as the magnetic field application portion applying magnetic field to rotor 60; and light sources 801, 802 serving as the varying portion capable of acting on rotor 60 and varying the orientation of spin 41 of rotor 60. Light sources 801, 802 adjust the orientation of spin 41 of rotor 60 in such a manner that, when rotor 60 moves toward N pole permanent magnet 20 and S pole permanent magnet 30, rotor 60 and N pole permanent magnet 20, S pole permanent magnet 30 are attracted to each other, and when rotor 60 moves away from N pole permanent magnet 20 and S pole permanent magnet 30, rotor 60 and N pole permanent magnet 20, S pole permanent magnet 30 repulse from each other.

Light sources 801, 802 can vary the orientation of spin 41 by irradiating rotor 60 with light (electromagnetic wave). Another physical apparatus instead of light sources 801, 802 may vary the orientation of spin 41. The S pole is located in the direction of the arrowhead of spin 41. As a pair of N pole permanent magnet 20 and S pole permanent magnet 30 is arranged above and under rotor 60, each of N pole permanent magnet 20 and S pole permanent magnet 30 interacts with spin 41 and rotor 60 rotates. Spin 41 of functional material 40 varies its orientation upon receiving external energy such as light.

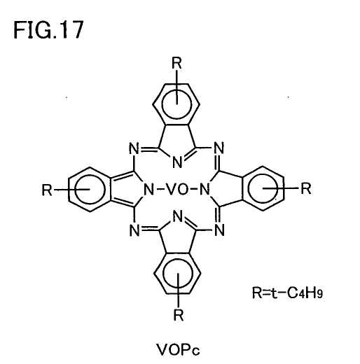

FIG. 16 shows a structural formula of F₁₆CuPc composing the functional material, and FIG. 17 shows a structural formula of VOPc composing the functional material. In the first and second embodiments above, F₁₆CuPc or VOPc shown in FIGS. 16 and 17 may be adopted as functional material 40.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

1. A quantum motor, comprising:
a rotor containing a functional material of which quantum characteristic is controllable;
a magnetic field application portion applying magnetic field to said rotor; and
a varying portion varying the quantum characteristic of said rotor; wherein
said varying portion varies the quantum characteristic of said rotor, so that rotation force is generated in said rotor and said rotor rotates.

2. The quantum motor according to claim 1, wherein
said varying portion controls the quantum characteristic of said rotor by externally supplying physical energy to said rotor.

3. The quantum motor according to claim 1, wherein
said physical energy is supplied to a part of said rotor.

4. The quantum motor according to claim 1, wherein
said rotor contains an antiferromagnetic material and the functional material.

5. The quantum motor according to claim 1, wherein
said varying portion varies the quantum characteristic of said rotor, so that a current flows in said rotor and the current and magnetic field act on each other, whereby rotation force is generated in said rotor.

6. The quantum motor according to claim 1, wherein
said varying portion varies the quantum characteristic of said rotor, so that rotation force is generated in said rotor as a result of magnetic interaction between said rotor and said magnetic field.

7. A quantum motor, comprising:
a rotor containing a material allowing current flow from an irradiated portion to another portion as a result of irradiation of a part of the rotor with electromagnetic wave;
a magnetic field application portion applying magnetic field to said rotor; and
an irradiation portion irradiating the part of said rotor with the electromagnetic wave; wherein
said irradiation portion irradiates the part of said rotor with the electromagnetic wave, so that the current flows from said irradiated portion to said another portion and said rotor rotates as a result of interaction between the current and the magnetic field.

8. A quantum motor, comprising:
a rotor containing a material capable of varying orientation of magnetic moment;
a magnetic field application portion applying magnetic field to said rotor; and
a varying portion capable of acting on said rotor and varying the orientation of the magnetic moment of the rotor; wherein
said varying portion adjusts the orientation of the magnetic moment of said rotor in such a manner that, when said rotor moves toward said magnetic field application portion, said rotor and said magnetic field application portion are attracted to each other, and when said rotor moves away from said magnetic field application portion, said rotor and said magnetic field application portion repulse from each other.

9. The quantum motor according to claim 1, wherein said rotor contains phthalocyanine.
